(19) United States
(12) Patent Application Publication
(10) Pub. No.: US 2015/0287992 A1
(43) Pub. Date: Oct. 8, 2015

(54) LITHIUM SULFUR SECONDARY BATTERY

(71) Applicant: WASEDA UNIVERSITY, Tokyo (JP)

(72) Inventors: Tetsuya OSAKA, Tokyo (JP); Toshiyuki MOMMA, Tokyo (JP); Tokihiko YOKOSHIMA, Tokyo (JP); Hiroki NARA, Tokyo (JP)

(73) Assignee: WASEDA UNIVERSITY, Tokyo (JP)

(21) Appl. No.: 14/671,416

(22) Filed: Mar. 27, 2015

(30) Foreign Application Priority Data
Apr. 4, 2014 (JP) 2014-077894

(51) Int. Cl. H01M 4/62; H01M 10/052; H01M 4/58

(52) U.S. Cl. CPC H01M 4/62; H01M 4/58; H01M 10/052; H01M 2004/028

(57) ABSTRACT

A lithium sulfur secondary battery includes a positive electrode containing a sulfur-based positive electrode active substance, an electrolytic solution, a negative electrode containing a negative electrode active substance that occludes and releases lithium, and a polymeric film that covers a surface of the positive electrode and allows lithium cations to pass but does not allow polysulfide anions to pass.

### CROSS REFERENCE TO RELATED APPLICATION

This application is based upon and claims priority from Japanese Patent Application No. 2014-077894 filed in Japan on Apr. 4, 2014, the entire contents of which are incorporated herein by reference.

### BACKGROUND OF THE INVENTION

1. Field of the Invention

The present invention relates to a lithium sulfur secondary battery including a positive electrode containing a sulfur-based positive electrode active substance.

2. Description of the Related Art

A large-capacity secondary battery is in great demand according to spread of cellular phones and researches and development of electric vehicles and hybrid electric vehicles adapted to environmental problems. As such a secondary battery, a lithium ion secondary battery has already been widely spread.

As a secondary battery having a larger capacity than the lithium ion secondary battery, a lithium sulfur battery including sulfur as a positive electrode active substance is attracting attention. A theoretical capacity of sulfur is approximately 1670 mAh/g. The theoretical capacity of sulfur is approximately ten times as large as a theoretical capacity of LiCoO₂ (approximately 140 mAh/g), which is a representative positive electrode active substance of a lithium ion battery. Further, there is an advantage that sulfur is inexpensive and is abundant as resources.

As indicated by following reaction formulas 1 to 5, in the lithium sulfur battery, during electric discharge, in a positive electrode, for example, elemental sulfur (S₈) is sequentially reduced to S₈²⁻(1), S₆²⁻(2), S₄²⁻(3), and S₂²⁻(3) to be polysulfide anions. Finally, Li₂S is generated (5). On the other hand, in a negative electrode, lithium in the negative electrode is discharged as lithium ions. The lithium ions reach the positive electrode through an electrolytic solution and change to an Li source for the Li₂S generation.

### (Reaction Formulas 1 to 5)

S₈+2e⁻←→Li₂S₈ (1)

3S₈+8e⁻←→4Li₂S₆ (2)

S₈²⁻+2e⁻←→2Li₂S₄ (3)

S₄²⁻+2e⁻←→2Li₂S₂ (4)

S₂²⁻+2e⁻+4Li⁻←→2Li₂S (5)

Lithium polysulfide including polysulfide such as S₈²⁻, S₆²⁻, S₄²⁻, and S₂²⁻, which are reduction products of sulfur, and lithium easily dissolves in an organic solvent and is eluted into an electrolytic solution of a battery. Since positive electrode active substances decrease because of the elution of the lithium polysulfide, a charging and discharging capacity of the battery decreases.

Further, during charging, anion polysulfide eluted to the electrolytic solution is reduced when reaching a negative electrode surface and is oxidized when reaching a positive electrode surface. A short-circuit due to substance movement occurs in the electrolytic solution. Then, charging and discharging power efficiency is markedly deteriorated by a so-called shuttle effect, which means that the battery is not charged even if a charging current continues to be applied.

Japanese Patent Application Laid-Open Publication No. 2012-109223 discloses a lithium sulfur secondary battery in which an ionic liquid including a complex of glyme and Li salt is used as an electrolytic solution. The ionic liquid including the complex of the glyme and the Li salt has low solubility of lithium polysulfide. Therefore, for example, a decrease in a charging and discharging capacity is prevented.

### SUMMARY OF THE INVENTION

A lithium sulfur secondary battery according to an embodiment of the present invention includes: a positive electrode containing a sulfur-based positive electrode active substance; an electrolyte; a negative electrode containing a negative electrode active substance that occludes and releases lithium; and a polymeric film that covers an interface between the positive electrode and the electrolyte and allows lithium cations to pass but does not allow polysulfide anions to pass.

### BRIEF DESCRIPTION OF THE DRAWINGS

FIG. 1 is a configuration diagram of a lithium sulfur secondary battery in an embodiment;

FIG. 2 is a schematic diagram for explaining an effect of a polymeric film of the lithium sulfur secondary battery in the embodiment;

FIG. 3 is a perspective view of a manufacturing apparatus for the polymeric film of the lithium sulfur secondary battery in the embodiment;

FIG. 4 is a voltage/current curve during electrolytic polymerization of the polymeric film of the lithium sulfur secondary battery in the embodiment;

FIG. 5 is a diagram showing charging and discharging characteristics of a conventional lithium sulfur secondary battery;

FIG. 6 is a diagram showing charging and discharging characteristics of the lithium sulfur secondary battery in the embodiment;

FIG. 7 is a diagram showing cycle characteristics of the lithium sulfur secondary battery in the embodiment and the conventional lithium sulfur secondary battery;

FIG. 8 is a diagram showing IR spectra of the polymeric film and the like of the lithium sulfur secondary battery in the embodiment; and

FIG. 9 is a diagram showing a result of a UV spectroscopic analysis for evaluating sulfur dissolution amounts of an electrolytic solution of the lithium sulfur secondary battery in the embodiment and the conventional lithium sulfur secondary battery.

### DETAILED DESCRIPTION OF THE PREFERRED EMBODIMENTS

A lithium sulfur secondary battery 10 (hereinafter also referred to as “battery”) in an embodiment of the present invention is explained below.

### <Configuration>

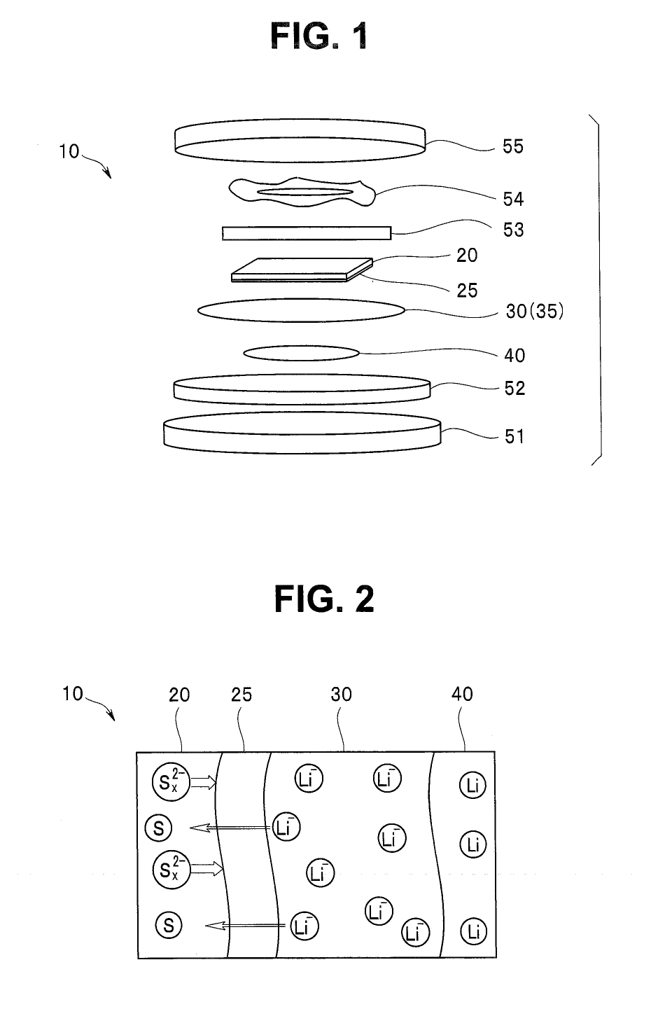

As shown in FIG. 1, the battery 10 includes, as main components, a positive electrode 20 containing a sulfur-based positive electrode active substance, an electrolytic solution 30, which is an electrolyte, and a negative electrode 40 containing a negative electrode active substance that occludes and releases lithium ions.

In the battery 10, the positive electrode 20 and the negative electrode 40 are disposed to be separated via a separator 35. The electrolytic solution 30 is contained in the separator 35 to configure a unit cell. That is, a coin cell case 51, a gasket 52, the negative electrode 40, the separator 35 (the electrolytic solution 30), the positive electrode 20, a spacer 53, a spring washer 54, and an upper lid 55 are disposed in order.

The battery 10 further includes a polymeric film 25 that covers an interface between the positive electrode 20 and the electrolytic solution 30. As shown in FIG. 2, the polymeric film 25 allows lithium cations to pass but does not allow polysulfide anions and other sulfide anion lithium salts to pass. Therefore, in the battery 10, elution of sulfur from the positive electrode 20 to the electrolytic solution 30 can be prevented.

The components of the battery 10 are explained in order. <Positive electrode>

Elemental sulfur (S₈) was used as the sulfur-based electrode active substance. 50 weight of elemental sulfur (S) was mixed and Ketjen black (KB) serving as a conductive agent was mixed at a ratio of 50 weight %. Heating treatment for twelve hours was performed under an argon atmosphere at 155° C., whereby an S/KB (sulfur/Ketjen black) complex was manufactured.

10 weight % of polyvinylidene fluoride (PVdF) was added to the S/KB complex as a binder. An appropriate amount of N-methyl-2-pyrrolidone (NMP) was added to the S/KB complex. The S/KB complex to which the polyvinylidene fluoride and the N-methyl-2-pyrrolidone were added was kneaded into a slurry state. After the obtained slurry was applied to a nickel foil (a current collector) having thickness of 20 μm, the slurry was dried and the NMP was evaporated. Thereafter, the nickel foil was pressed, whereby the positive electrode 20 containing the S/KB was manufactured. Thickness of the positive electrode 20 is 15 μm to 20 μm and a weight ratio of the positive electrode 20 is S/KB/PVdF=4.5/4.5/1.0.

Note that the positive electrode 20 only has to include a sulfur-based active substance containing at least one selected out of a group consisting of elemental sulfur, metal sulfide, metal polysulfide, and an organic sulfur compound. Examples of the metal sulfide include lithium polysulfide; Li₂Sₙ (1≦n≦8). Examples of the metal polysulfide include TSₙ (T=Ni, Co, Cu, Fe, Mo, Ti, 1≦n≦4). Examples of the organic sulfur compound include an organic disulfide compound and a carbon sulfide compound.

The positive electrode 20 may contain a binder and a conductive agent in addition to the sulfur-based active substance. Slurry (paste) of these electrode materials is applied to a conductive carrier (current collector) and dried, whereby a positive electrode is manufactured with the electrode materials carried on the carrier. Examples of the current collector include conductive metals such as aluminum, nickel, copper, and stainless steel formed as a foil, mesh, expand grid (expand metal), punched metal, and the like. Resin having conductivity or resin containing a conductive filler may be used as the current collector. Thickness of the current collector is, for example, 5 to 30 μm but is not limited to this range.

A content of the positive electrode active substance in the complex is preferably 50 to 98 mass % and more preferably 80 to 98 mass %. It is suitable that the content of the active substance is in the range because energy density can be increased. Thickness of an electrode material (thickness of one surface of an application layer) is preferably 10 to 500 μm, more preferably 20 to 300 μm, and still more preferably 10 to 50 μm.

Examples of the binder include polyethylene (PE), polypropylene (PP), polyethylene terephthalate (PET), polyether nitrile (PEN), polyimide (PI), polyamide (PA), polytetrafluoroethylene (PTFE), styrene-butadiene rubber (SBR), polyacrylonitrile (PAN), polymethyl acrylate (PMA), polymethyl methacrylate (PMMA), polyvinyl chloride (PVC), polyvinylidene fluoride (PVDF), polyvinyl alcohol (PVA), polyacrylic acid (PAA), lithium polyacrylate (PAALi), polyalkylene oxide such as a ring-opened polymer of ethylene oxide or monosubstituted epoxide, or mixtures of the foregoing.

### <Negative Electrode>

The negative electrode 40 was manufactured by sticking a lithium metal plate having thickness of 200 μm to a stainless steel disk having thickness of 500 μm.

Note that the negative electrode only has to contain one or two or more negative electrode active substances selected out of a group consisting of lithium, a lithium alloy, carbon or metal capable of occluding and releasing lithium, a complex of lithium/inactive sulfur, and a sodium alloy. The negative electrode active substance contained in the negative electrode acts to occlude and release lithium ions. As the negative electrode active substance, it is possible to use publicly-known negative electrode materials such as metal materials including lithium titanate, lithium gold, sodium metal, a lithium aluminum alloy, a lithium tin alloy, a lithium silicon alloy, a sodium silicon alloy, and a lithium antimony alloy, and carbon materials like crystalline carbon materials and amorphous carbon materials including natural graphite, artificial graphite, carbon black, acetylene black, graphite, activated carbon, carbon fiber, coke, soft carbon, and hard carbon. Among the negative electrode materials, it is desirable to use the carbon materials, lithium, or a lithium transition metal complex oxide because a battery excellent in a capacity and input and output characteristics can be manufactured.

### <Electrolytic Solution>

As the electrolytic solution 30, an ionic liquid including a complex of Li salt and glyme was used. As the Li salt, Li-TFSI (lithium(trifluoromethylsulfonyl)imide) indicated by Formula 6 was used.

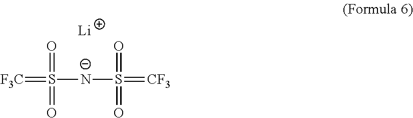

The glyme includes an ether linkage in a molecule. For example, dimethyl glycol (DME) is a common name of 1,2-dimethoxyethane and is also called monoglyme (G1). Like the monoglyme, 1,3-dioxolane (DOL), which is cyclic ether, also has a low molecular weight and low viscosity and is inexpensive for the glyme.

Two molecules of each of DME and DOL form a complex with one molecule of Li-TFSI.

The electrolytic solution 30 is an ionic liquid obtained by dissolving 1 mol/L of TFSI in DME/DOL=1/1 (volume ratio).

### <Separator>

The separator 35 disposed between the positive electrode 20 and the negative electrode 40 is not an essential component. However, the separator 35 can reduce an inter-electrode distance and has a function of carrying the electrolytic solution.

In the battery 10 in the embodiment, a polypropylene porous sheet is used as the separator 35.

Examples of the separator 35 include a separator made of glass fiber that absorbs and retains the electrolytic solution, a porous sheet made of polymer, and nonwoven fabric. The porous sheet is formed of, for example, microporous polymer. Examples of the polymer forming such a porous sheet include polyolefin such as polyethylene (PE) and polypropylene (PP), a stacked body having a three-layer structure of PP/PE/PP, polyimide, and aramid. In particular, the polyolefin microporous separator and the separator made of glass fiber are preferable because the separators have a chemically stable characteristic against an organic solvent and can suppress reactivity with the electrolytic solution. The thickness of the separator made of the porous sheet is not limited. However, in a use of a secondary battery for motor driving of an automobile, it is preferable that the separator is a single layer or a multilayer and has overall thickness of 4 to 60 μm. It is preferable that a micro hole diameter of the separator made of the porous sheet is 10 μm or less at the maximum (normally, approximately 10 to 100 nm) and porosity of the separator is 20 to 80%.

### <Polymeric Film>

As explained above, the battery 10 includes the polymeric film 25 that covers the positive electrode 20.

The polymeric film 25 is formed on the positive electrode 20 by an electrolytic oxidation polymerization method using a polymerization liquid 61 containing a pyrrole monomer and an ionic liquid.

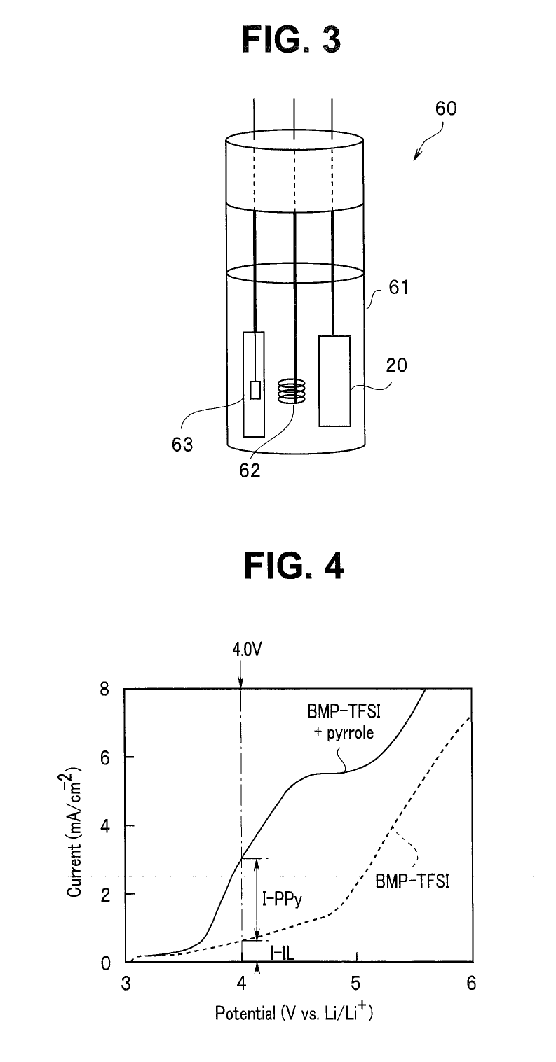

A basic configuration of an electrolytic polymerization device 60 is shown in FIG. 3. The electrolytic polymerization device 60 is a three-electrode type cell including the positive electrode 20, which is made of the nickel foil on which the S/KB complex is formed, as an action electrode, a platinum wire as a counter electrode, and metal lithium as a reference electrode.

As the polymerization liquid 61, an ionic liquid (BMP-TFSI) containing 0.1 mol/L of pyrrole monomer and 1 mol/L of Li-TFSI was used. That is, the polymerization liquid 61 contains anions TFSI same as anions TFSI of the electrolytic solution 30.

A polymerization temperature was set to a room temperature (25° C.). However, by setting the polymerization temperature to temperature exceeding the room temperature, for example, 80° C., it is possible to more efficiently form the polymeric film 25.

BMP (1-butyl-1-methylpyrrolidinium) is pyrrolidinium having a five membered ring as indicated by Formula 7 below.

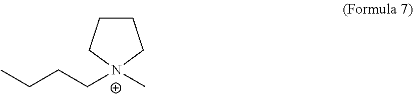

In FIG. 4, potential/current curves of the polymerization liquid 61 (BMPTFSI+pyrrole) and a solution (BMPTFSI) not containing the pyrrole monomer are shown. In the polymerization liquid 61, a polymerization reaction of the pyrrole monomer is considered to advance at potential of 3.5 V or higher and 4.5 V or lower. However, at low potential, a ratio of an electric current (I-IL) due to a decomposition reaction of the ionic liquid (BMPTFSI) is large with respect to an electric current (I-PPy) due to the polymerization reaction. Therefore, film formation potential is preferably 3.8 V or higher and 4.0 V or lower.

The polymeric film 25 was formed by feeding an electric current of 2 C/cm² at film formation potential of 4.2 V. The thickness of the formed polymeric film 25 was approximately 5 μm.

As explained below, a crack or the like was not observed on a surface of the polymeric film 25 observed by an electron microscope. The surface was smooth.

The polymeric film 25 contains polypyrrole as a main component. The ionic liquid in the polymerization liquid 61 is considered to be integrated in the polypyrrole and fixed. Note that, in the polymeric film 25 containing the polypyrrole as the main component, theoretically, 25 weight % to 40 weight % of TFSI is contained.

Thickness of the polymeric film 25 is, for example, preferably 0.5 μm or more and 20 μm or less and particularly preferably 2 μm or more and 10 μm or less. When the thickness is smaller than the range, a blocking effect for polysulfide ions is insufficient. When the thickness exceeds the range, electric resistance is high.

### <Manufacturing Method>

Next, a manufacturing method for the battery 10 is briefly explained.

In a glove box under an argon atmosphere, an appropriate amount of the electrolytic solution 30 was added to the positive electrode 20 on which the polymeric film 25 was formed. The electrolytic solution 30 was penetrated into the positive electrode 20 for 60 minutes at 60° C. After the positive electrode 20 and the negative electrode 40 were stacked via the separator 35 and the electrolytic solution 30 was further injected, the positive electrode 20 and the negative electrode 40 were encapsulated in the coin cell case 51 of a 2032 type (made of SUS304 and having thickness of 3.2 mm) The spacer 53 was placed on the negative electrode 40. The spring washer 54 was disposed on the spacer 53. The coin cell case 51 was sealed by the upper lid 55 via the spring washer 54. The lithium-sulfur battery 10 having structure shown in FIG. 1 was manufactured. Note that the gasket 52 is interposed on a sidewall of the coin cell case 51.

### <Evaluation>

A characteristic evaluation result and an analysis result of the battery 10 in the embodiment manufactured by the method explained above are explained below. Note that, for comparison, a battery of a comparative example having the same configuration as the battery 10 and without a polypyrrole film (PPy) disposed on the positive electrode 20 was also manufactured and evaluated and analyzed in the same manner.

In a charging and discharging evaluation, cutoff potential was set to 1.5 V to 3.0 V (vs. Li/Li⁺), charging and discharging speed was set to 3.0 C, and current density was set to 25 μA/cm². In cyclic voltammetry measurement (CV), cutoff potential was set to 1.5 V to 3.0 V (vs. Li/Li⁺) and scanning speed was set to 0.1 mV/s.

For the analysis, a field emission type scanning electron microscope (FE-SEM), infrared spectroscopy (IR), and ultraviolet/visible spectroscopy (UV-Vis) were used.

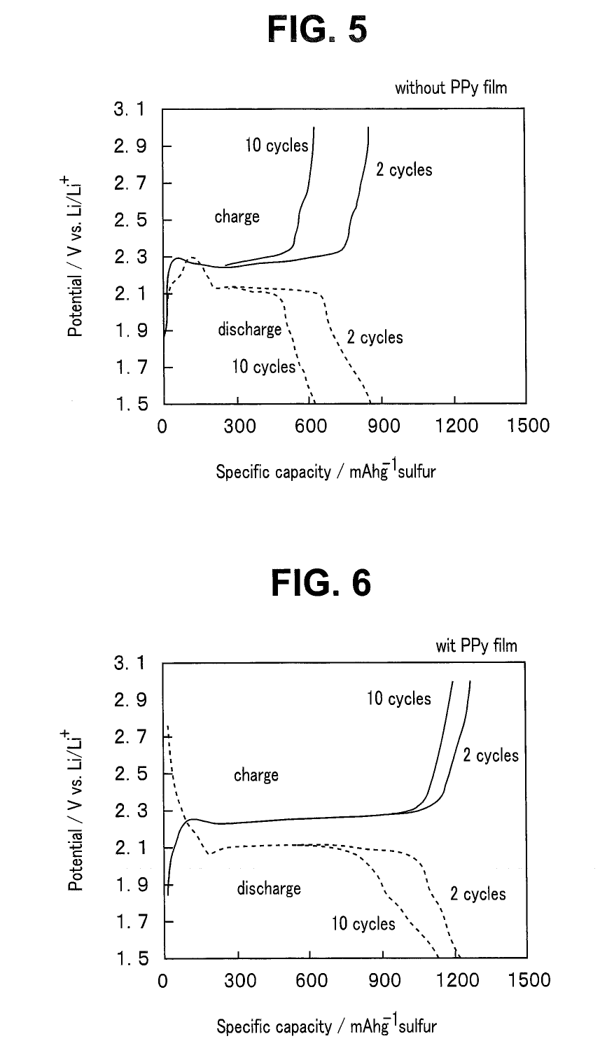

Charging and discharging characteristics are shown in FIGS. 5, 6, and 7.

Compared with the battery (without PPy) of the comparative example shown in FIG. 5, the battery 10 (with PPy) shown in FIG. 6 has a large initial capacity. This is considered to be because a rate of use of the active substance in the positive electrode is improved by coating of the polypyrrole film.

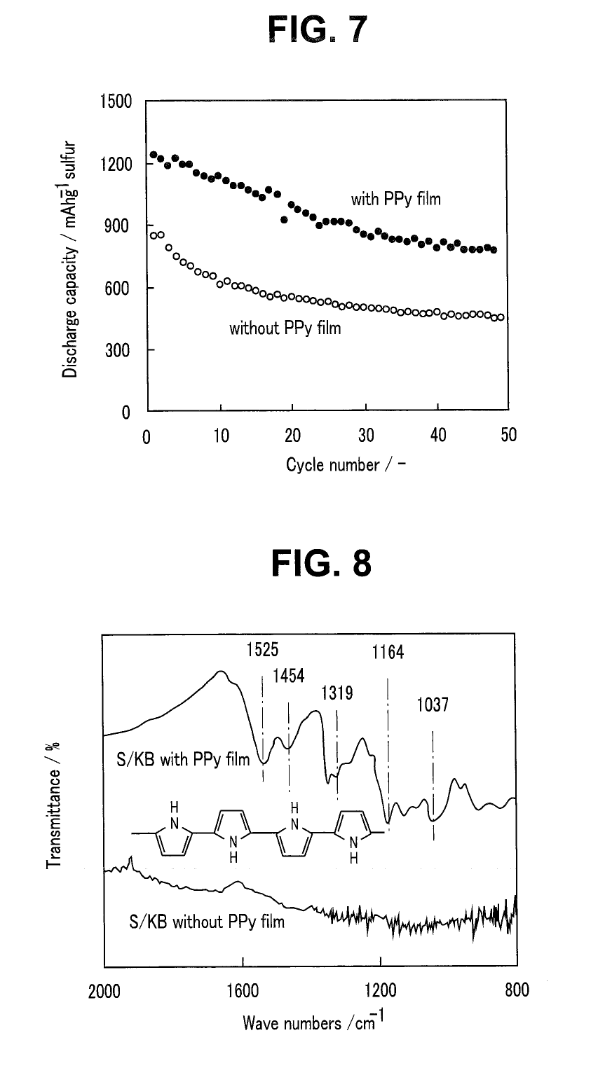

Further, as shown in FIG. 7, even after 50 cycles, the battery 10 (with PPy) maintains a large capacity close to an initial characteristic of the battery (without PPy) of the comparative example.

From above result, it is evident that a decrease in a charging and discharging capacity is more greatly prevented in the battery 10 (with PPy) in the embodiment than in the battery (without PPy) of the comparative example.

A result of a structure analysis of the polymeric film 25 is shown in FIG. 8. In an IR measurement spectrum shown in FIG. 8, 1525 cm⁻¹ and 1454 cm⁻¹ are absorption peaks due to stretching vibration of an aromatic ring C═C and indicate that the polymeric film 25 has a pyrrole ring. 1349 cm⁻¹ and 1037 cm⁻¹ are absorption peaks due to in-plane deformation vibration of ═C—H. 1164 cm⁻¹ is an absorption peak due to C—N stretching vibration.

From the above, it has been confirmed that the polymeric film 25 is the polypyrrole shown in FIG. 8.

From surface observation by the FE-SEM, the surface of the polymeric film 25 was relatively smooth. A crack and the like were not observed.

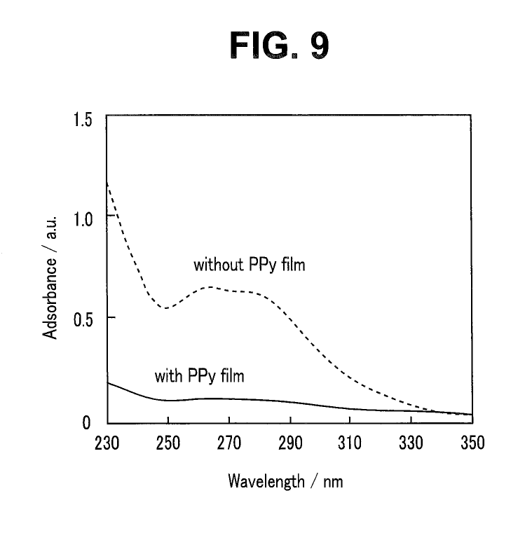

A sulfur dissolution amount evaluation result in an electrolytic solution by UV measurement is shown in FIG. 9. The battery 10 subjected to a charging and discharging test at 10 cycles was disassembled and the separator 35 was spun in a centrifugal separator to collect the electrolytic solution 30. It is known that sulfur has an absorption peak at 230 nm to 350 nm

In the electrolytic solution 30, which is the ionic liquid including the complex of the glyme and the Li salt, an elution amount of sulfur is small. It has been confirmed that, in the battery 10 including the polymeric film 25, an elution amount of sulfur is smaller.

From the above result, in the battery 10 (with PPy) in the embodiment, it has been confirmed that, since elution of lithium polysulfide generated in the positive electrode 20 to the electrolytic solution 30 is small because of the polymeric film 25 containing the polypyrrole film as a main component, a decrease in a charging and discharging amount is suppressed. <Modifications>

Various modifications of the battery 10 in the embodiment are possible.

The polymerization liquid for forming the polymeric film 25 with the electrolytic oxidation polymerization method only has to contain the pyrrole monomer and the ionic liquid.

As anions of the ionic liquid of the polymerization liquid, BF₄—, PF₆—, and the like can also be used.

As cations of the ionic liquid of the polymerization liquid, TMPA+ (trimethylpropylammonium) and MTOA+ (methyltrioctylammonium), which are cations of a chainlike structure, and MPP (1-methyl-1-propylpyrrolidinium), MPPp+ (1-methyl-1-propylpiperidinium), and BMPp+ (1-methyl-1-butylpiperidinium), which are cations of an annular structure, may be used.

However, from the viewpoint of improvement of characteristics of the battery, for example, improvement of a capacity and a cycle characteristic, the cations of the annular structure, in particular, cations having a five membered ring are preferable. A cause of this is uncertain. However, it is probably because, since the cations have the same five membered ring pyrrolidinium as pyrrole, the cations are easily absorbed in the polypyrrole film and stably retained in molecules of polypyrrole.

However, in the polymeric film 25 formed using the polymerization liquid 61 in the embodiment, an important reaction advanced at the normal temperature (25° C.) and the capacity and the cycle characteristic of the battery were the best.

Note that, as the electrolytic solution, various kinds of ionic liquids including the complex of the Li salt and the glyme can be used. As the glyme, triglyme (G3), tetraglyme (G4), and the like may be used. However, in the battery in the embodiment, the anion polysulfide less easily is eluted to the electrolytic solution. Therefore, it is also possible to suitably use glymes having two or less ether linkages having low viscosity. As in the electrolytic solution 30, a plurality of kinds of glymes may be mixed and used. Naturally, various kinds of organic solvents used in the conventional lithium ion battery may be used.

Note that, in the above explanation, for the experiment, the battery 10 having a simple structure is explained. However, the battery 10 may be, for example, a battery having a structure in which a plurality of unit cells like the battery 10 are stacked or a battery having a structure in which cells having the same stacked structure are wound around and housed in a case. The electrolytic solution 30 may be a gel electrolyte or a solid electrolyte.

That is, the present invention is not limited to the embodiments and the like explained above. It goes without saying that various changes, combinations, and applications are possible without departing from the spirit of the invention.

What is claimed is:

1. A lithium sulfur secondary battery comprising:
a positive electrode containing a sulfur-based positive electrode active substance;
an electrolyte;
a negative electrode containing a negative electrode active substance that occludes and releases lithium; and
a polymeric film that covers an interface between the positive electrode and the electrolyte and allows lithium cations to pass but does not allow polysulfide anions to pass.

2. The lithium sulfur secondary battery according to claim 1, wherein the polymeric film contains polypyrrole as a main component and includes an ionic liquid.

3. The lithium sulfur secondary battery according to claim 2, wherein the polymeric film is formed on the positive electrode by an electrolytic oxidation polymerization method using a polymerization liquid containing a pyrrole monomer and the ionic liquid.

4. The lithium sulfur secondary battery according to claim 3, wherein the ionic liquid includes anions and cations having a five membered ring.

5. The lithium sulfur secondary battery according to claim 4, wherein the anions are TFSI, and the cations having the five membered ring are BMP+ (five membered pyrrolidinium).

6. The lithium sulfur secondary battery according to claim 5, wherein the polymerization liquid contains lithium cations.

7. The lithium sulfur secondary battery according to claim 6, wherein anions of the electrolyte are same as the anions of the polymerization liquid.
